(19) United States
(12) Patent Application Publication
(10) Pub. No.: US 2014/0130008 A1
(43) Pub. Date: May 8, 2014

(54) GENERATING INFORMATION MODELS

(71) Applicant: James Michael AMULU, Bangalore (IN)

(72) Inventor: James Michael AMULU, Bangalore (IN)

(21) Appl. No.: 13/668,329

(22) Filed: Nov. 5, 2012

(51) Int. Cl. G06F 9/44

(52) U.S. Cl. 717/105; 717/104

(57) ABSTRACT

Various embodiments of systems and methods for generating information models are described herein. In one aspect, the method includes determining a type of a to-be-generated. In one embodiment, the type of the to-be-generated model is determined by determining whether the to-be-generated model includes one or more quantifiable data fields and when the to-be-generated model includes the one or more quantifiable data fields, determining whether the quantifiable data fields are from a single source. Based upon the type of the to-be-generated model, a section of code is selected for generating a model corresponding to the to-be-generated model. The selected section of code is executed to generate the model.

### BACKGROUND

Information models are generated to model various combinations of data stored in a database. Information models are generated for various purposes such as for performing analysis, generating reports, etc. Examples of various types of information models include an attribute view, an analytical view, and a calculation view. Different editors are used to generate different types of information models. A user is required to specify a type of information model each time an information model is to be generated. Based upon the specified type of information model, a suitable editor is used to generate the information model. However, specifying the type of information model to be generated each time might be inconvenient. Further, if the user mistakenly specifies a wrong information model type, the information model cannot be later changed to another type during generation. Therefore, in order to change the type of the information model the user is required to start all over again which consumes effort and time.

### BRIEF DESCRIPTION OF THE DRAWINGS

The claims set forth the embodiments with particularity. The embodiments are illustrated by way of examples and not by way of limitation in the figures of the accompanying drawings in which like references indicate similar elements. The embodiments, together with its advantages, may be best understood from the following detailed description taken in conjunction with the accompanying drawings.

FIG. 1 is a block diagram of a system including an editor for generating various types of models, according to an embodiment.

FIG. 2 illustrates a model development environment, according to an embodiment.

FIG. 3 illustrates a user interface providing an option to create a package within a content node of the model development environment, according to an embodiment.

FIG. 4 illustrates a user interface providing input fields for creating the package, according to an embodiment.

FIG. 5 illustrates a user interface displaying the package created within the content node of the model development environment, according to an embodiment.

FIG. 6 illustrates a user interface providing an option for creating a model within the package, according to an embodiment.

FIG. 7 illustrates a user interface providing input fields for creating the model, according to an embodiment.

FIG. 8 illustrates a user interface for selecting tables to be included within the model, according to an embodiment.

FIG. 9 illustrates a user interface including a data foundation tab for defining the tables to be included within the model, according to an embodiment.

FIG. 10 illustrates the data foundation tab providing options for categorizing data fields of the tables to be included within the model, according to an embodiment.

FIG. 11 illustrates a user interface including a logical view tab for defining relationship between the tables, according to an embodiment.

FIG. 12 illustrates a user interface providing an option for activating the model, according to an embodiment.

FIG. 13 illustrates various sections of codes corresponding to various types of models, according to an embodiment.

FIG. 14 is a flow chart illustrating the steps to generate a model, according to an embodiment.

FIG. 15 is a flow chart illustrating the steps to determine a type of the model to be generated, according to an embodiment.

FIG. 16 is a block diagram of an exemplary computer system, according to an embodiment.

### DETAILED DESCRIPTION

Embodiments of techniques for generating information models are described herein. In the following description, numerous specific details are set forth to provide a thorough understanding of the embodiments. One skilled in the relevant art will recognize, however, that the embodiments can be practiced without one or more of the specific details, or with other methods, components, materials, etc. In other instances, well-known structures, materials, or operations are not shown or described in detail.

Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

In-memory database is a database which typically relies on main memory for computation and storage. The in-memory database may be a relational database, an object oriented database, or a hybrid of both. The in-memory database utilizes the maximum capabilities of an underlying hardware to increase performance. The possibility to perform fast calculations on in-memory data, allows fast ad-hoc reporting based on business requirements and business transaction data. Thus, complex analytics can be performed based on business requirements. Information required for processing are available in the main memory, so computation and read operations can be executed in the main memory, without involving a hard disk input/output operation.

A database table or a table is typically a two dimensional data structure with cells organized in rows and columns. However, in the typical in-memory database, memory organization is linear. In a linear memory organization, data may be stored as a row store or a column store. In a row store, fields of every row of the table are stored in a row sequentially, whereas in a column store, the fields of every column are stored in a column, in contiguous memory locations. Row based storage and column based storage store data and metadata, which can be accessed by various components of the in-memory management system, such as any development tool, a query processing engine, and the like.

Data field is a container of data or a place where data can be stored within the database table. In one embodiment, the data fields refer to different columns of the database table. For example, in the database table related to users, the columns such as a ‘user ID,’ a ‘user name,’ and a ‘user address,’ etc., are referred as data fields.

Quantifiable data field is a type of a data field which comprises measurable data or data having a numerical value. For example, the data field ‘sales quantity’ may be defined as ‘quantifiable’ data field as the ‘sales quantity’ is measurable data and includes numerical values. In one embodiment, the quantifiable data field is referred as ‘measure.’

Non-quantifiable data field is the type of the data field which comprises non-measurable or non-numerical data. For example, the data field ‘user name’ may be defined as ‘non-quantifiable’ data field as the ‘user name’ is not measurable. Typically, the non-quantifiable data field comprises a descriptive data. In one embodiment, the non-quantifiable data field is referred as ‘attribute.’

Model development environment (MDE) is a type of a modeling tool used for generating models based on the business requirements. In one embodiment, the models are generated corresponding to the in-memory database. The MDE may be a front-end development tool such as, for example, ‘information modeler’ within SAP® high-performance analytic appliance (HANA®) studio. In one embodiment, the MDE may be an interactive development wizard, where a corresponding user input is requested at every step. Typically, the MDE provides a graphical user interface of the underlying in-memory database and used at design-time to create models. Generally, the design-time is referred to as a design or development phase prior to compiling the software code.

Information model or model is a design-time artifact which provides a logical view of the data and its relationship, using the underlying tables in the in-memory database. The design-time artifact is by-product produced during the development of software, such as tables, views, functions, schema, models, and the like. The model is the design time artifact generated using one or more database tables. In one embodiment, only some data fields of the database tables are selected for generating the model. The database tables are logically connected to generate the model. In one embodiment, the model may be one of a type namely an attribute view, an analytical view, and a calculation view.

Attribute view is a type of the model which includes only attributes or non-quantifiable data fields. In one embodiment, the attribute view models an entity comprising the non-quantifiable data fields from one or more database tables. The entity may be modeled based on a relationship between the data fields of the one or more database tables. In one embodiment, the attribute view is termed as a join type of column view.

Analytical view is a type of the model which includes one or more quantifiable data fields (measures) from a single database table. Therefore, the analytical view models quantifiable data fields of the single database table. In one embodiment, the analytical view also includes at least one of one or more non-quantifiable data fields and one or more attribute views. In one embodiment, the analytical view is termed as an on-line analytical processing (OLAP) type of column view.

Calculation view is a type of the model which includes a plurality of quantifiable data fields (measures) from multiple database tables. Typically, the calculation view models more advanced combination of data stored in the database. In one embodiment, the calculation view also includes at least one of one or more non-quantifiable data fields, one or more attribute views, and one or more analytical views. In one embodiment, the calculation view is termed as a calculation type of column view.

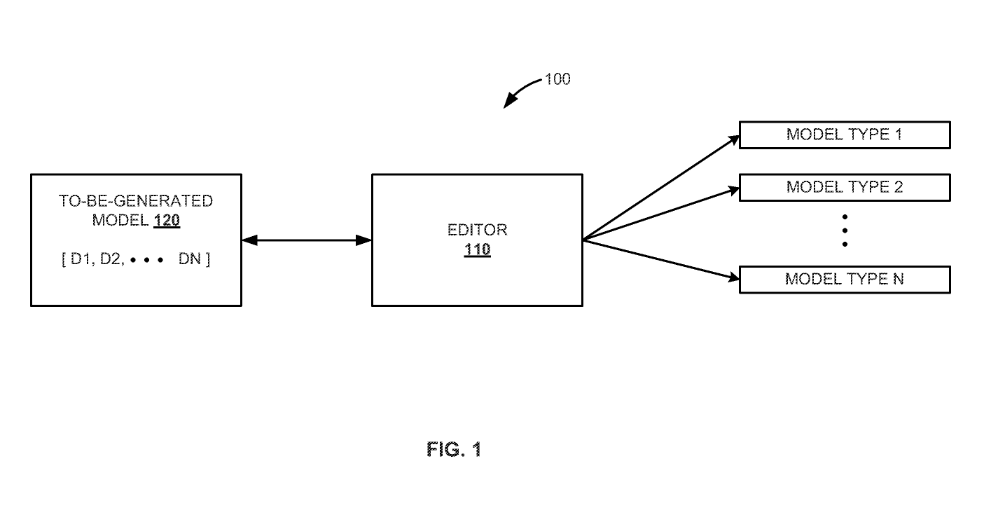

FIG. 1 illustrates one embodiment of a system 100 including an editor 110 for generating models of various types, e.g., model type 1-model type N. The editor 110 identifies a to-be-generated or yet-to-be-generated model 120. The to-be-generated model 120 includes a plurality of data fields D1-DN. In one embodiment, the plurality of data fields D1-DN is from one or more database tables (not shown). Each of the data fields D1-DN is one of a type namely a quantifiable data field and a non-quantifiable data field. The editor 110 determines the type of each data field D1-DN. In one embodiment, based upon the type of the data field D1-DN, the editor 110 determines a type of the to-be-generated model 120. For example, when the data fields D1-DN are non-quantifiable data fields, the editor 110 determines that the to-be-generated model 120 is of model type 1. The editor 110 selects a section of code (not shown) corresponding to the model type of the to-be-generated model 120. The selected section of code is executed to generate the to-be-generated model 120.

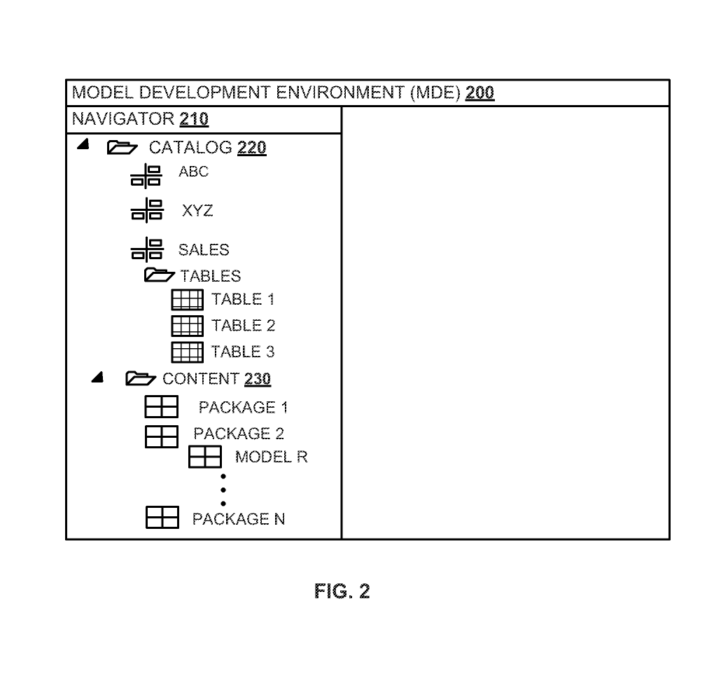

The to-be-generated model 120 may be generated using a model development environment (MDE). In one embodiment, the MDE may be a front end development tool. FIG. 2 illustrates an exemplary MDE 200. In one embodiment, the MDE 200 includes a navigator 210. The navigator 210 displays a ‘catalog’ 220. The ‘catalog’ 220 provides available data sources. The data sources may be pre-created models, tables, views, etc. In one embodiment, the data sources may be pre-created schemas such as ABC, XYZ, and SALES and one or more database tables within each schema such as the database tables table 1-table 3 within the schema SALES. Typically, the tables are segregated under suitable schemas within the ‘catalog’ 220. For example, the table 1-table 3, related to sales, are included under the ‘SALES’ schema. In one embodiment, the ‘catalog’ 220 is a node which provides design-time artifacts or available data sources in a form of a hierarchical tree. For example, the ‘catalog’ 220 provides schemas and database tables within each schema in the form of the hierarchical tree. The ‘catalog’ 220 provides schemas and database tables within schemas for creating various types of models. For example, using the tables, e.g., table 1-table 3, various types of models related to sales may be generated.

In one embodiment, the models are generated and stored within a package. The package may be created under another node ‘content’ 230 in the navigator 210. The ‘content’ 230 represents a design-time repository which holds all the packages and models created within the packages. In one embodiment, the models are organized within the package in the ‘content’ 230. A user (e.g., a business analyst) creates the package and then creates one or more models within the package. For example, the user may create the package 2 and a model ‘R’ within the package 2.

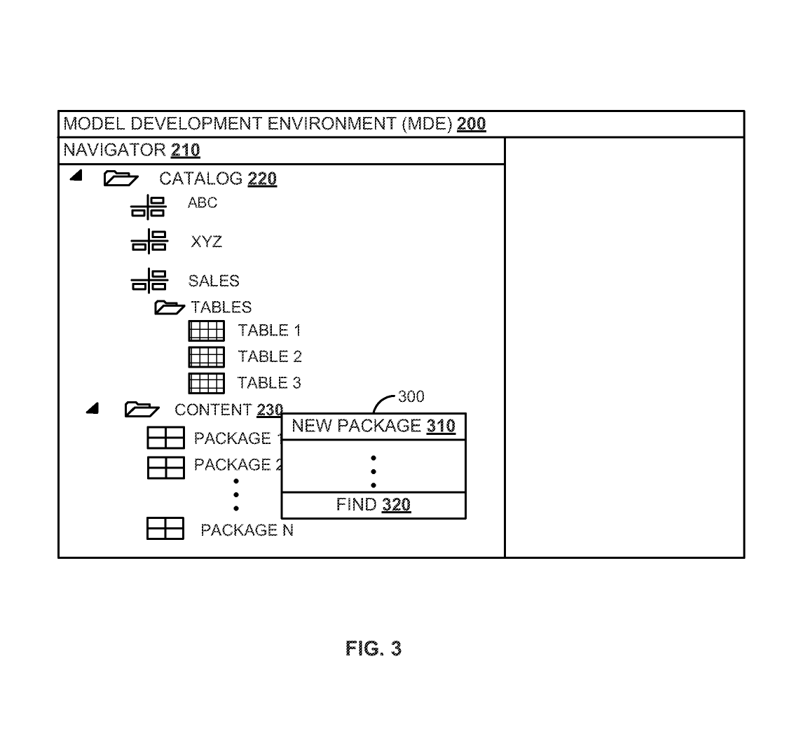

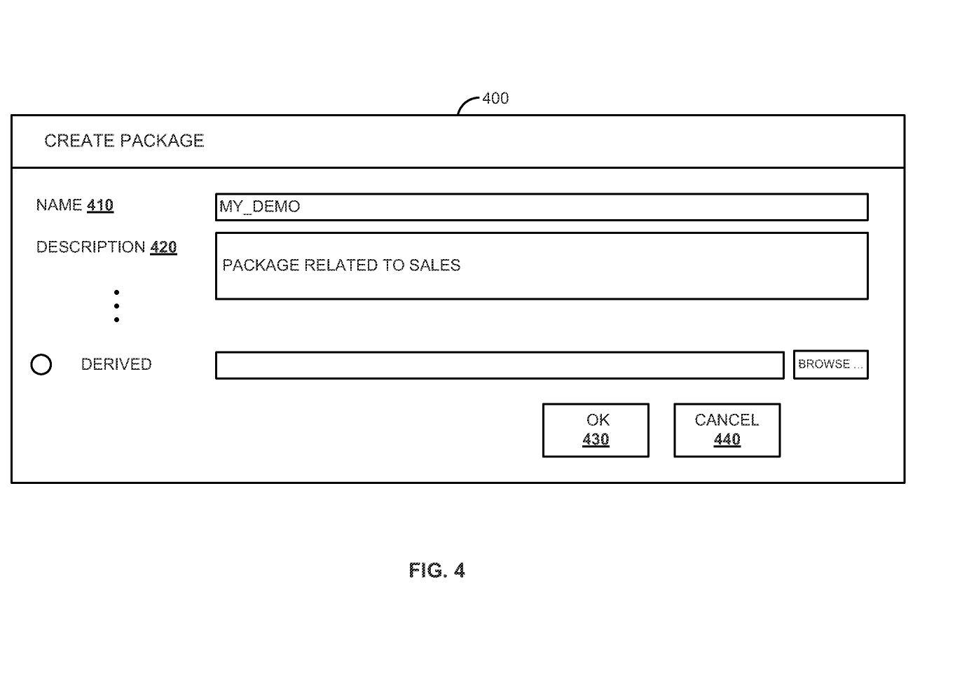

In one embodiment, for creating a new package, the user selects the ‘content’ 230. The ‘content’ 230 may be selected by right clicking the ‘content’ 230. FIG. 3 illustrates a menu 300 generated upon right clicking the ‘content’ 230. The menu 300 includes various options, e.g., ‘new package’ 310 for creating new package within the ‘content’ 230, ‘find’ 320 for searching existing packages or models within the ‘content’ 230. Upon selecting the option ‘new package’ 310, a user interface 400 (FIG. 4) is displayed. The user interface 400 includes input fields, e.g., ‘name’ 410. The user can provide a name of the new package, e.g., my_demo, in the input field ‘name’ 410. In one embodiment, the user interface 400 also includes another input field ‘description’ 420. In the ‘description’ 420, the user can provide a short description about the package.

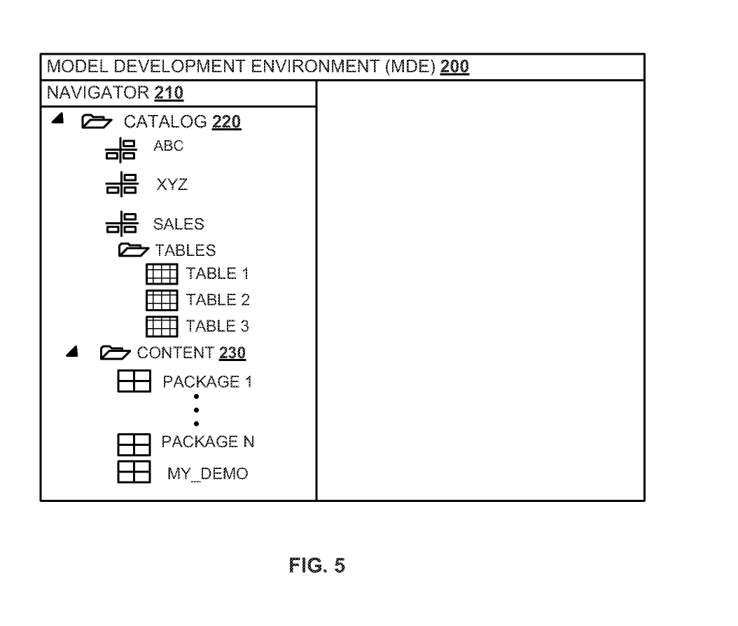

In one embodiment, the input field ‘name’ 410 is mandatory while the input field ‘description’ 420 is an optional field. In one embodiment, the mandatory field is marked with a suitable symbol such as ‘*.’ Once the ‘name’ 410 and/or ‘description’ 420 are provided, the user can select ‘OK’ 430 to complete the generation of the new package ‘my_demo.’ Once the package ‘my_demo’ is created, the package ‘my_demo’ is displayed within the ‘content’ 230, as shown in FIG. 5. In one embodiment, the user can cancel the creation of the new package by selecting ‘cancel’ 440 on the user interface 400.

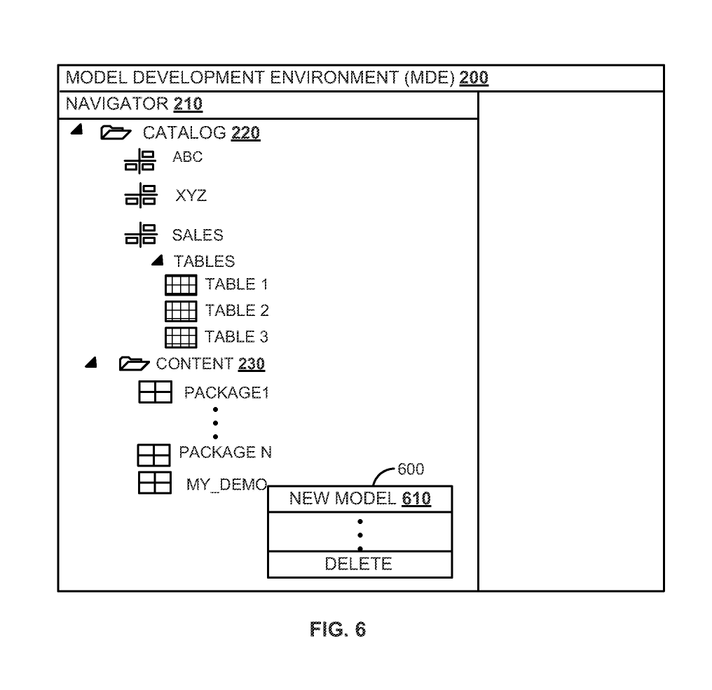

Various types of models can be created within the package ‘my_demo.’ In one embodiment, referring to FIG. 6, for creating models within the package ‘my_demo,’ the user selects (e.g., right clicks) the package ‘my_demo’ placed within the ‘content’ 230. A menu 600 is generated upon selecting the package ‘my_demo.’ The menu 600 provides various options, e.g., an option ‘new model’ 610 for creating a new model within the package ‘my_demo’. Upon selecting the option ‘new model’ 610, the new model is created within the package ‘my_demo.’

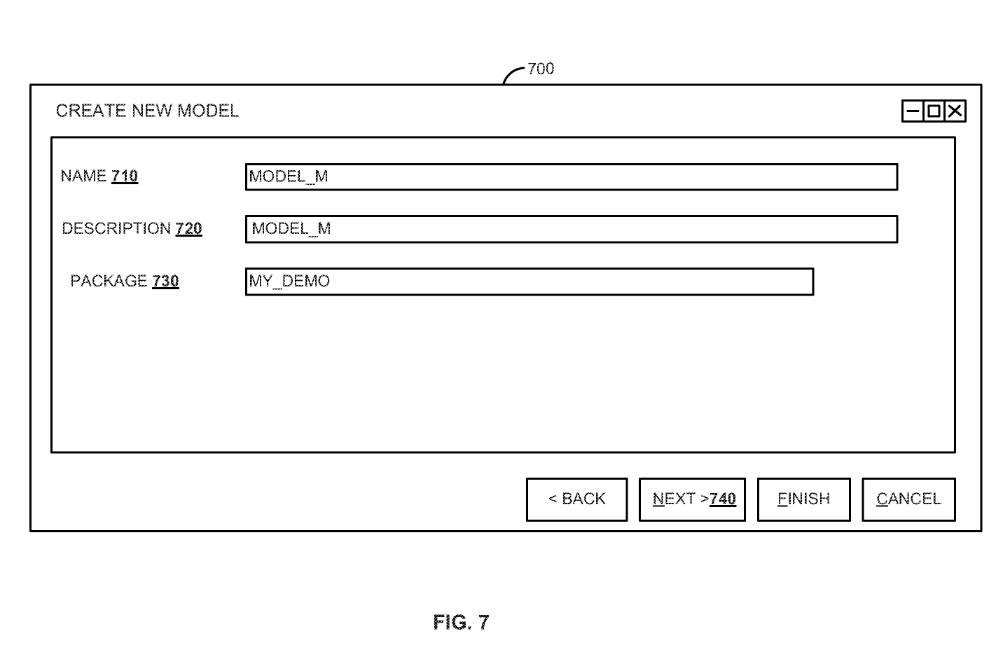

FIG. 7 illustrates a user interface 700 generated upon selecting the option ‘new model’ 610 of FIG. 6. The user interface 700 includes various input fields, e.g., ‘name’ 710 for providing the name of the new model, i.e., the to-be-generated model 120, ‘description’ 720 for providing a short description of the to-be-generated model 120. In one embodiment, the input field ‘name’ 710 is mandatory, while the field ‘description’ 720 is the optional input field. In one embodiment, the mandatory field is marked with a symbol ‘*.’ The user provides the ‘name’ 710 of the to-be-generated model 120, e.g., ‘model_M.’ Some fields on the user interface 700 are automatically populated. For example, the input field ‘package’ 730 is automatically populated with the name of the package, e.g., ‘my_demo,’ under which the model_M is to be generated. Once the ‘name’ 710 and/or the ‘description’ 720 are provided, the user can select ‘next’ 740 to proceed to next user interface to add tables to the model_M.

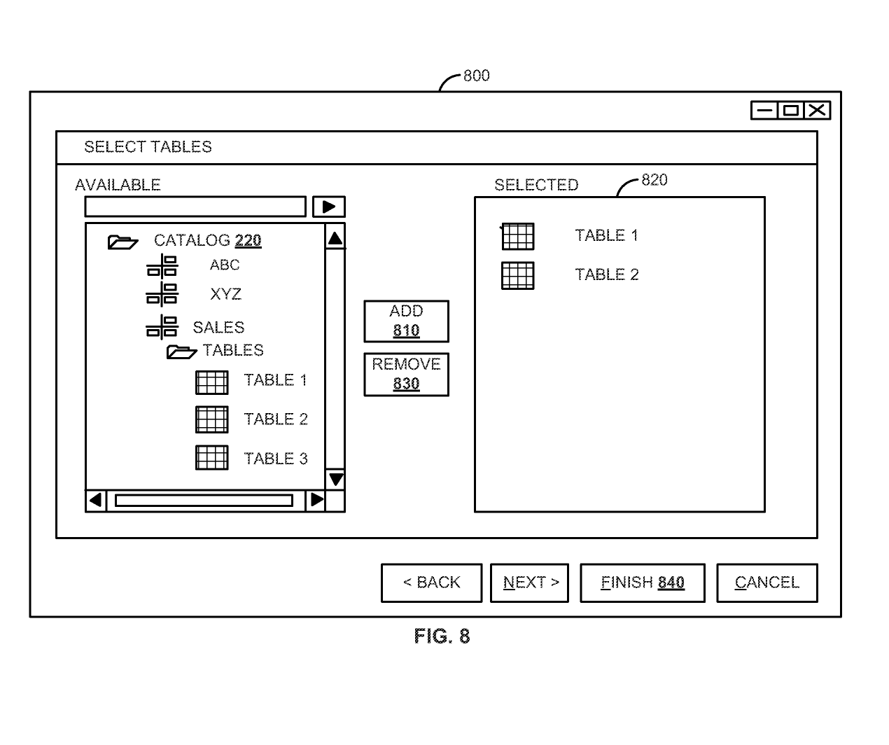

FIG. 8 illustrates a user interface 800 for adding tables to the model_M. The user interface 800 is displayed when the user selects the ‘next’ 740 option in the user interface 700 of FIG. 7. The user interface 800 displays the ‘catalog’ 220 including all available tables. As discussed, the tables are segregated under suitable schemas. For example, the tables related to sales are segregated under SALES schema. The user can select the tables of their choice from a suitable schema. For example, the user can select table 1 and table 2 from the SALES schema of ‘catalog’ 220 and selects ‘add’ 810 option to add the selected tables to a ‘selected window’ 820. In one embodiment, the user can choose to select the tables, e.g., table 1 and table 2, from the ‘selected window’ 820 and select ‘remove’ 830 option to remove the selected tables. The tables from the ‘selected window’ 820 are automatically included within the model_M. Once all the required tables are selected, the user can select ‘finish’ 840 option to proceed to next user interface to start defining the model_M.

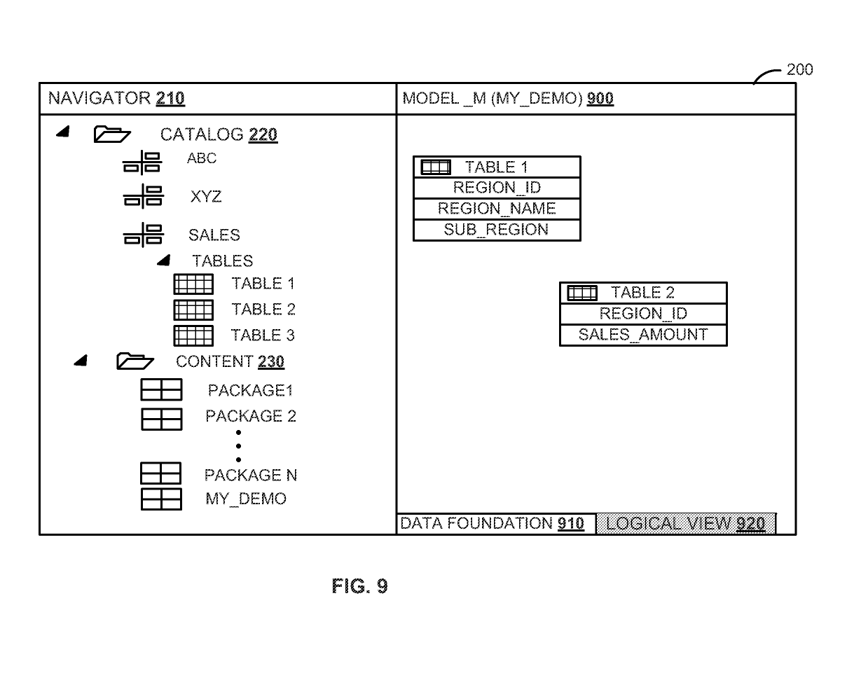

FIG. 9 illustrates a user interface 900 for defining the model_M. The user interface 900 is displayed when the user selects the ‘finish’ 840 option in the user interface 800. The user interface 900 includes a data foundation tab 910 and a logical view tab 920. The data foundation tab 910 is used for defining objects or tables of the to-be-generated model 120 or ‘model_M.’ The selected tables (e.g., table 1 and table 2) from the ‘selected window’ 820 is automatically displayed within the data foundation tab 910. In one embodiment, the user can drag-and-drop the tables or models from the ‘catalog’ 220 or the ‘content’ 230 upon the data foundation tab 910.

In one embodiment, as illustrated in FIG. 9, table 1 and table 2 are displayed as column tables in the data foundation tab 910. The column table includes a single column and each data field of the table is displayed as different rows under that single column. For example, the data fields such as ‘REGION_ID,’ ‘REGION_NAME,’ and ‘SUB_REGION’ of table 1 are illustrated as different rows under the single column in the table 1.

In one embodiment, the user can hide one or more data fields of the selected tables in the model_M. Typically, the data field may be hidden by changing a property (e.g., visibility) of the data field. The visibility of the data field may be changed in a property window (not shown) of the data field. In one embodiment, the user can double click the data field to open its property window to change the visibility of the data field.

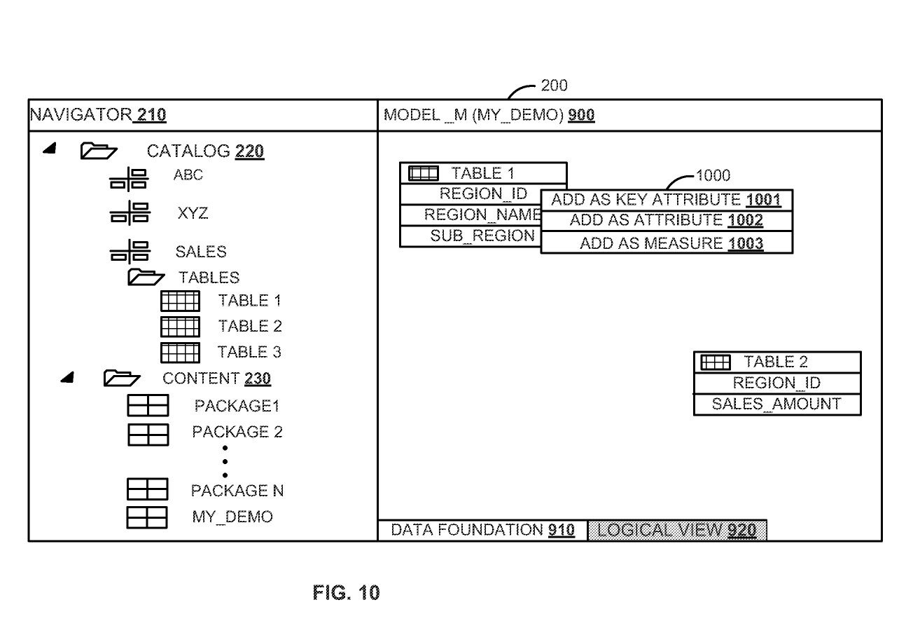

In one embodiment, the data fields of the table 1 and table 2 displayed on the data foundation tab 910 can be categorized or classified into various types. The data fields of the table 1 and table 2 is categorized into various types by the user. For specifying the type of the data field, the user selects or right clicks the data field. For example, the user right clicks the data field ‘REGION_ID’ of table 1. Once the data field, e.g., ‘REGION_ID,’ is right clicked, a menu 1000 is displayed as shown in FIG. 10. The menu 1000 includes various options, e.g., ‘add as key attribute’ 1001 to add the data field as a key attribute, ‘add as attribute’ 1002 to add the data field as the attribute or the non-quantifiable data field, and ‘add as measure’ 1003 to add the data field as the measure or the quantifiable data field, etc. The user can select the option of their choice. For example, the user can select the option ‘add as key attribute’ 1001 for the data field ‘REGION_ID,’ select the option ‘add as attribute’ 1002 for the data fields ‘REGION_NAME’ and ‘SUB_REGION’ of the table 1. Similarly, the user can select suitable option for the data fields of the table 2. For example, the user can select the option ‘add as key attribute’ 1001 for the data field ‘REGION_ID’ and ‘add as measure’ 1003 for the data field ‘SALES_AMOUNT’ of the table 2.

In one embodiment, when the user makes the data field ‘REGION_ID’ the key attribute, a symbol (e.g., symbol ‘*’) may be prefixed to the data field ‘REGION_ID’ to show that the ‘REGION_ID’ is the key attribute. Similarly, a suitable symbol may also be prefixed to the data fields categorized as the attribute and the measure. For example, a symbol may be prefixed to the data field ‘SALES_AMOUNT’ to show that it is the measure.

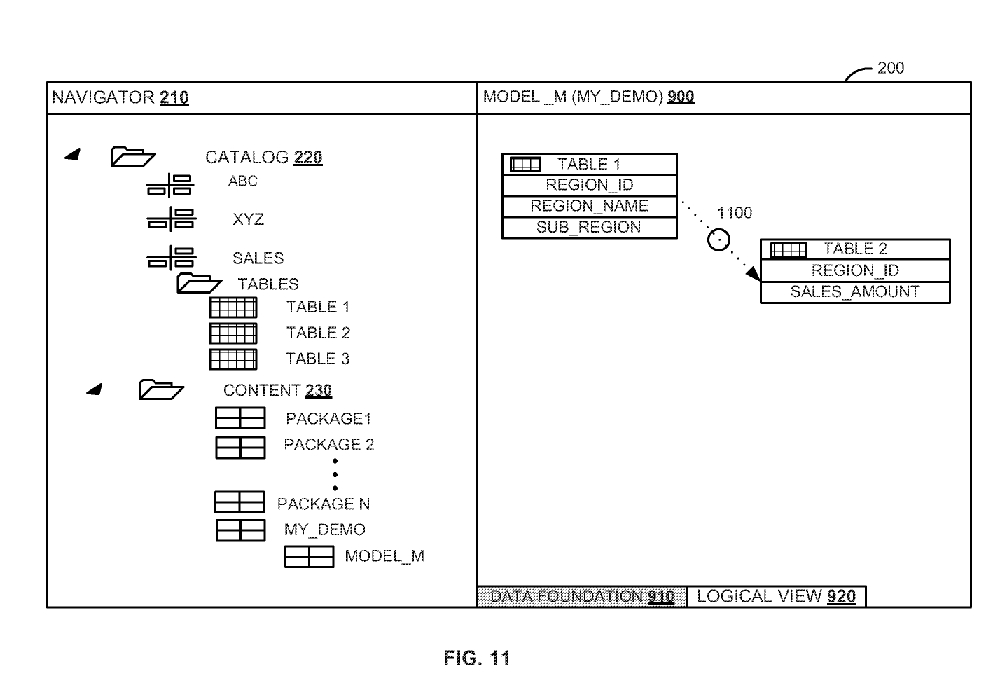

Once the data fields are categorized as the key attribute, attribute, and measure, the user can select the logical view tab 920. In the logical view tab 920, the user can define a relationship between the tables, e.g., the table 1 and the table 2. The relationship may be defined by associating the same data fields of the tables. For example, the data field ‘REGION_ID’ of table 1 and the data field ‘REGION_ID’ of table 2 is associated or linked, as illustrated in FIG. 11. In one embodiment, the data field ‘REGION_ID’ of table 1 and the data field ‘REGION_ID’ of table 2 is linked through a connector 1100. In one embodiment, when the user pulls the data field ‘REGION_ID’ of table 1, the connector 1100 is displayed. The connector 1100 can then be dragged and dropped to the data field ‘REGION_ID’ of table 2 to make the connection.

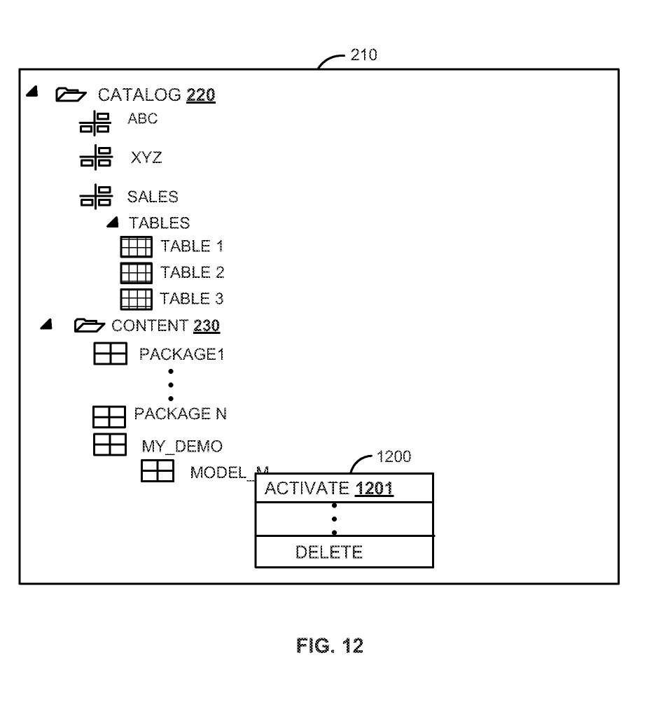

Once the relationship between the tables is defined, a placeholder for model_M is created and the model_M becomes visible in the ‘content’ 230. The user can activate model_M so that a real model corresponding to the model_M is generated. For activating model_M, the user right clicks the model_M within the ‘content’ 230. FIG. 12 illustrates a content menu 1200 displayed upon right clicking the model_M. The content menu 1200 can include various options including ‘activate’ 1201. The user can select the ‘activate’ 1201 option to generate the real model corresponding to model_M.

Upon activating model_M, the editor 110 identifies all the database tables, e.g., table 1-table 2, associated with the model_M. Once the table 1 and table 2 is identified, the editor 110 determines whether any data field of the table 1 and table 2 is quantifiable data field (measure). In case none of the data fields of the tables is measure, the editor 110 determines that the model_M is of type 1 or an attribute view. In case the one or more data fields are quantifiable data fields, the editor 110 determines whether the quantifiable data fields are from a single or same table. In case the quantifiable data fields, e.g., ‘SALES_AMOUNT,’ are from the same table, e.g., table 2, the editor 110 determines that the model_M is of type 2 or an analytical view. In case the quantifiable data fields are from multiple tables, then the editor 110 determines that the type of model_M is type 3 or a calculation view.

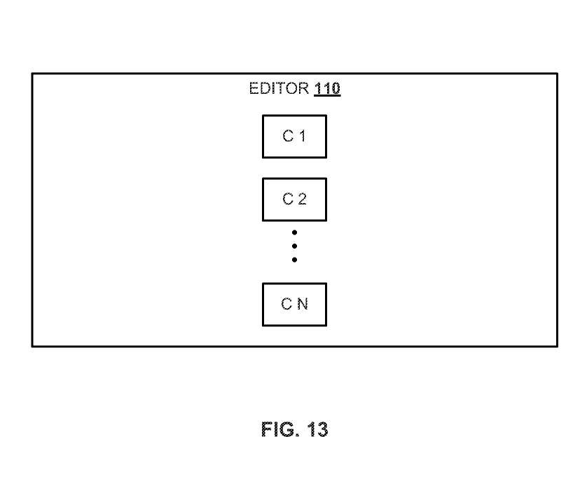

Once the type of the model_M is determined, the editor 110 automatically selects the section of code corresponding to the type of the model_M. Typically, each section of code corresponds to a type of the model or view. Various sections of codes are predefined corresponding to various model types. FIG. 13 shows various sections of codes C1-CN predefined corresponding to various model types such as model type 1-model type N. In one embodiment, the section of code C1 may corresponds to model type 1 or attribute view, the section of code C2 may corresponds to model type 2 or analytical view, and the section of code C3 may corresponds to model type 3 or calculation view. In one embodiment, the section of code C1-CN may be included within the editor, as illustrated in FIG. 13. In another embodiment, the section of codes C1-CN may be downloaded from cloud, e.g., from one or more servers (not shown).

The editor 110 automatically selects the section of code corresponding to the type of the model_M. For example, as the type of the model_M is analytical view, the editor 110 selects the section of code C2. The selected section of code, e.g., C2, is executed to generate the model corresponding to the model_M. The generated model is stored in a database. In one embodiment, the database is the in-memory database.

In one embodiment, the editor 110 assigns an identifier to the generated model based upon its type. In one embodiment, the editor 110 assigns the identifier by tagging (e.g., prefixing or post fixing) the name of the model with the identifier. For example, when the model_M is of type ‘attribute view,’ the editor 110 may prefix the name ‘model_M’ with the identifier ‘ATR.’ The user can easily identify the type of the model by reading their identifier. For example, the user can easily make out that the model_M is of type ‘attribute view’ from its identifier ‘ATR.’ In one embodiment, the identifier for each model type is predefined. For example, the identifier for model type 1 (e.g., the attribute view) may be predefined as ‘ATR’ or ‘ATTR,’ the identifier for model type 2 (e.g., the analytic view) may be predefined as ‘AV,’ and the identifier for model type N (e.g., the calculation view) may be predefined as ‘CAL.’ In one embodiment, the identifier may include any alphanumeric character, special symbols, and a combination thereof.

In one embodiment, the models are stored or segregated in the database based upon their respective types or identifiers. For example, all the models of the type ‘attribute view’ or identifier ‘ATR’ are stored together. In one embodiment, the models having the same prefix or post fix are stored or segregated under same category.

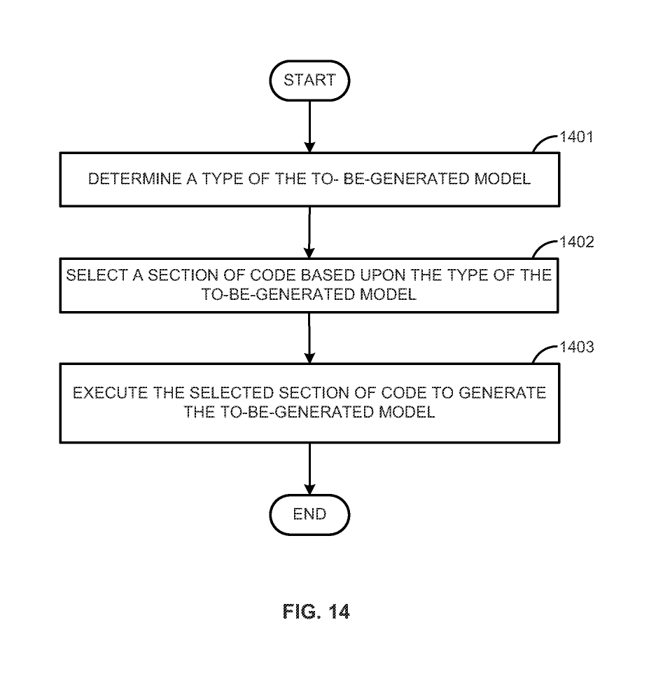

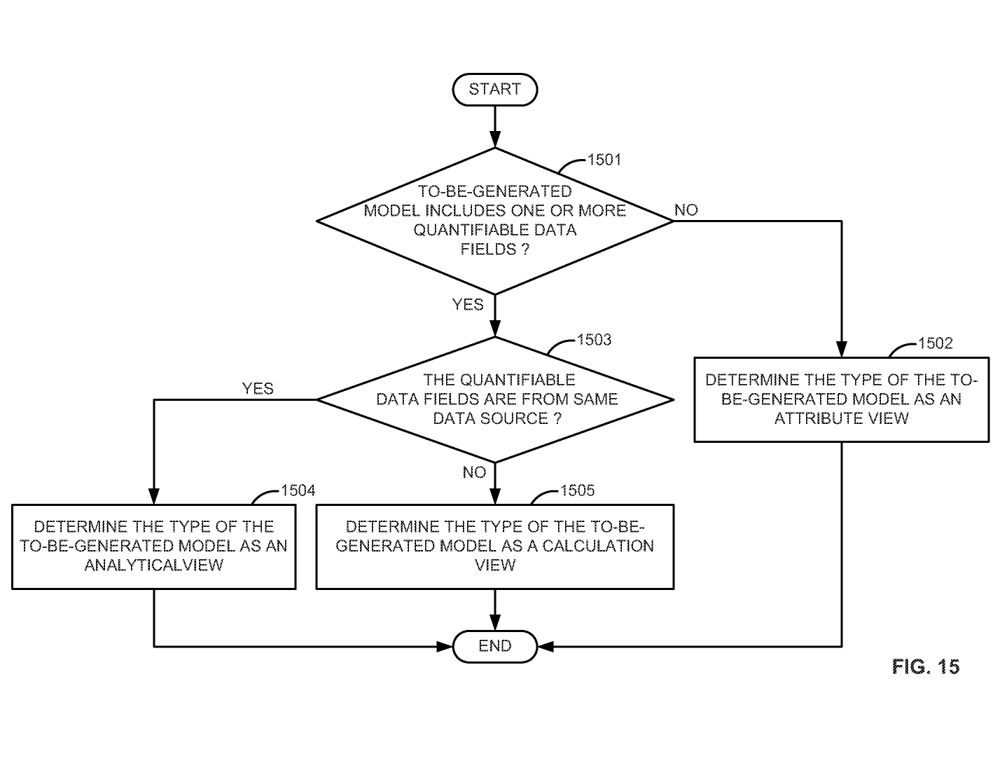

FIG. 14 is a flowchart illustrating a method for generating the to-be-generated model 120, according to an embodiment. The to-be-generated model 120, e.g., model_M, is defined by the user. In one embodiment, the user defines the to-be-generated model 120 by selecting the tables and categorizing each data field of the selected tables into the quantifiable data field (measure) and the non-quantifiable data field (attribute). In one embodiment, the user also defines the relationship or association between the selected tables. Once the to-be-generated model 120 is defined, the editor 110 identifies the to-be-generated model 120. The editor 110 determines the type of the to-be-generated model 120 at step 1401. One of the methods for determining the type of the to-be-generated model 120 is explained in reference to FIG. 15. The editor 110 automatically selects the section of code corresponding to the type of the to-be-generated model 120 at step 1402. For example, when the type of the to-be-generated model 120 is the analytical view, the editor 110 automatically selects the section of code C2. At step 1403, the selected section of code, e.g., C2, is executed to generate the to-be-generated model 120.

FIG. 15 is a flowchart illustrating a method for determining the type of the to-be-generated model 120, according to an embodiment. Once the to-be-generated model 120, e.g., model_M, is identified, the editor 110 determines the type of the to-be-generated model 120. In one embodiment, the editor 110 determines the type of the to-be-generated model 120 by determining whether the to-be-generated model 120 includes the one or more measures or quantifiable data fields at step 1501. When the to-be-generated model 120 does not include any quantifiable data fields (step 1501: NO), the editor 110 determines the type of the to-be-generated model 120 as the attribute view at step 1502. In case the to-be-generated model 120 includes the one or more quantifiable data fields (step 1501: YES), the editor 110 determines whether the quantifiable data fields are from the same data source at step 1503. In case the quantifiable data fields are from the same source (step 1503: YES), the editor 110 determines the type of the to-be-generated model 120 as the analytical view at step 1504. In case the quantifiable data fields are not from the same source (step 1503: NO), the editor 110 determines the type of the to-be-generated model 120 as the calculation view at step 1505. Based upon the type of the to-be-generated model 120, the section of code is selected to generate the to-be-generated model 120.

Embodiments described above enable generating different types of models using a single editor. As there is a single editor, therefore, a user is not required to pre-specify the model type for selecting a suitable editor. Also, the user has a flexibility to switch from one model type to another, during generation, as the model type is not pre-specified. Therefore, the editor is more generic, flexible, and efficient. Additionally, the editor automatically identifies the model type and segregates the models based upon their respective type or category so that the models can be easily reused later.

Some embodiments may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic indicator devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

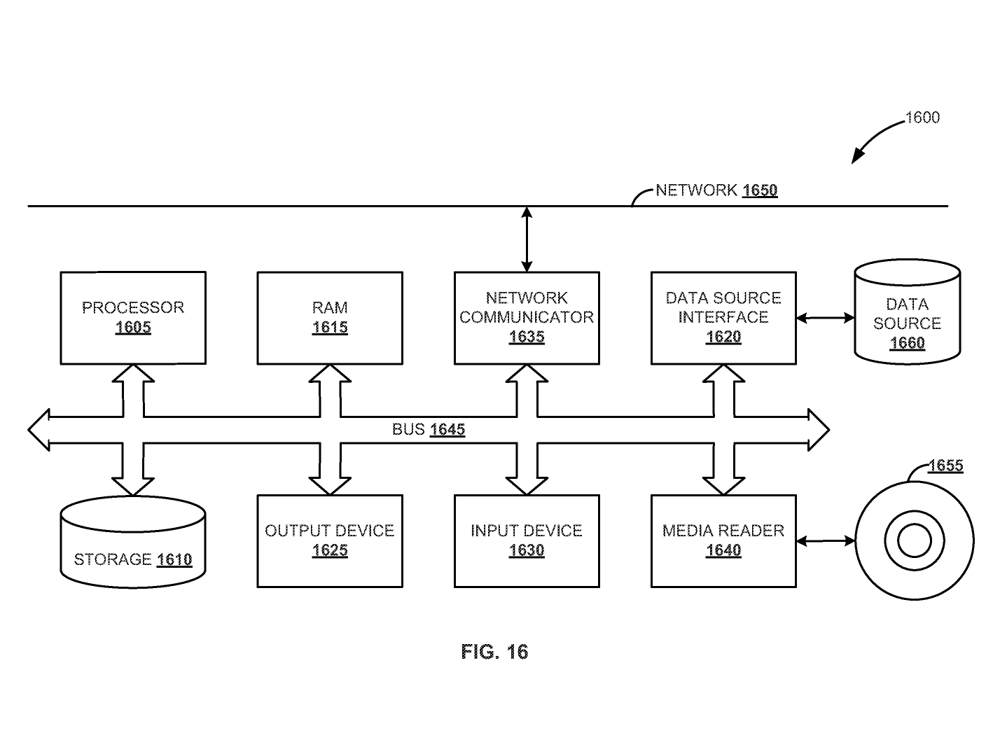

FIG. 16 is a block diagram of an exemplary computer system 1600. The computer system 1600 includes a processor 1605 that executes software instructions or code stored on a computer readable storage medium 1655 to perform the above-illustrated methods. The processor 1605 can include a plurality of cores. The computer system 1600 includes a media reader 1640 to read the instructions from the computer readable storage medium 1655 and store the instructions in storage 1610 or in random access memory (RAM) 1615. The storage 1610 provides a large space for keeping static data where at least some instructions could be stored for later execution. According to some embodiments, such as some in-memory computing system embodiments, the RAM 1615 can have sufficient storage capacity to store much of the data required for processing in the RAM 1615 instead of in the storage 1610. In some embodiments, all of the data required for processing may be stored in the RAM 1615. The stored instructions may be further compiled to generate other representations of the instructions and dynamically stored in the RAM 1615. The processor 1605 reads instructions from the RAM 1615 and performs actions as instructed. According to one embodiment, the computer system 1600 further includes an output device 1625 (e.g., a display) to provide at least some of the results of the execution as output including, but not limited to, visual information to users and an input device 1630 to provide a user or another device with means for entering data and/or otherwise interact with the computer system 1600. Each of these output devices 1625 and input devices 1630 could be joined by one or more additional peripherals to further expand the capabilities of the computer system 1600. A network communicator 1635 may be provided to connect the computer system 1600 to a network 1650 and in turn to other devices connected to the network 1650 including other clients, servers, data stores, and interfaces, for instance. The modules of the computer system 1600 are interconnected via a bus 1645. Computer system 1600 includes a data source interface 1620 to access data source 1660. The data source 1660 can be accessed via one or more abstraction layers implemented in hardware or software. For example, the data source 1660 may be accessed by network 1650. In some embodiments the data source 1660 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open Database Connectivity (ODBC), produced by an underlying software system, e.g., an ERP system, and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the one or more embodiments can be practiced without one or more of the specific details or with other methods, components, techniques, etc. In other instances, well-known operations or structures are not shown or described in details.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the embodiments to the precise forms disclosed. While specific embodiments of, and examples for, the embodiment are described herein for illustrative purposes, various equivalent modifications are possible within the scope of the embodiments, as those skilled in the relevant art will recognize. These modifications can be made to the embodiments in light of the above detailed description. Rather, the scope of the one or more embodiments are to be determined by the following claims, which are to be interpreted in accordance with established doctrines of claim construction.

What is claimed is:

1. An article of manufacture including a non-transitory computer readable storage medium to tangibly store instructions, which when executed cause one or more computers in a network of computers to:
determine a type of a yet to be generated model, comprising:
determine whether the yet to be generated model includes one or more quantifiable data fields; and
when the yet to be generated model includes the one or more quantifiable data fields, determine whether the quantifiable data fields are from a single data source;
select a section of code corresponding to the type of the yet to be generated model; and
execute the selected section of code to generate the yet to be generated model.

2. The article of manufacture of claim 1, wherein the quantifiable data fields are measurable data fields having numerical values.

3. The article of manufacture of claim 1, wherein the type of the yet to be generated model includes one of an attribute view, an analytical view, and a calculation view.

4. The article of manufacture of claim 3, wherein determining the type of the yet to be generated model further comprises:
determining the type of the yet to be generated model as the attribute view when the yet to be generated model does not include the one or more quantifiable data fields;
determining the type of the yet to be generated model as the analytical view when the yet to be generated model includes the one or more quantifiable data fields from the single data source; and
determining the type of the yet to be generated model as the calculation view when the yet to be generated model includes the one or more quantifiable data fields from more than one data sources.

5. The article of manufacture of claim 1 further comprising instructions which when executed cause the one or more computers in the network of computers to:
based upon the type of the yet to be generated model, assign an identifier to the generated model; and
store the generated model in a database under a respective category corresponding to the identifier.

6. The article of manufacture of claim 5, wherein the database is an in-memory database.

7. The article of manufacture of claim 1, wherein the one or more quantifiable data fields and non-quantifiable data fields are provided by a user.

8. The article of manufacture of claim 1, wherein the data source comprises one of a database table, a model, and a view.

9. A computer-implemented method for generating information models, the method comprising:
determining a type of a yet to be generated model, wherein determining the type of the yet to be generated model comprises:
determining whether the yet to be generated model includes one or more quantifiable data fields; and
when the yet to be generated model includes the one or more quantifiable data fields, determining whether the quantifiable data fields are from a single data source;
selecting a section of code corresponding to the type of the yet to be generated model; and
executing the selected section of code to generate the yet to be generated model.

10. The method of claim 9, wherein determining the type of the yet to be generated model further comprises:
determining the type of the yet to be generated model as an attribute view when the yet to be generated model does not include the one or more quantifiable data fields;
determining the type of the yet to be generated model as an analytical view when the yet to be generated model includes the one or more quantifiable data fields from the single data source; and
determining the type of the yet to be generated model as a calculation view when the yet to be generated model includes the one or more quantifiable data fields from more than one data sources.

11. The method of claim 9 further comprising:
based upon the type of the yet to be generated model, assigning an identifier to the generated model; and
storing the generated model in a database under a respective category corresponding to the identifier.

12. The method of claim 11, wherein the one or more quantifiable data fields and non-quantifiable data fields are provided by a user.

13. A computer system for generating information models, the computer system comprising:
a memory to store program code; and
a processor communicatively coupled to the memory, the processor configured to execute the program code to:
determine a type of a yet to be generated model, wherein determining the type of the yet to be generated model comprises:
determining whether the yet to be generated model includes one or more quantifiable data fields; and
when the yet to be generated model includes the one or more quantifiable data fields, determining whether the quantifiable data fields are from a single data source;
select a section of code corresponding to the type of the yet to be generated model; and
execute the selected section of code to generate the yet to be generated model.

14. The computer system of claim 13, wherein the quantifiable data fields are measurable data fields having numerical values.

15. The computer system of claim 13, wherein the processor is further configured to execute the program code to:
determine the type of the yet to be generated model as an attribute view when the yet to be generated model does not include the one or more quantifiable data fields;
determine the type of the yet to be generated model as an analytical view when the yet to be generated model includes the one or more quantifiable data fields from the single data source; and
determine the type of the yet to be generated model as a calculation view when the yet to be generated model includes the one or more quantifiable data fields from more than one data sources.

16. The computer system of claim 13, wherein the one or more quantifiable data fields and non-quantifiable data fields are provided by a user.

17. The computer system of claim 13, wherein the processor is further configured to execute the program code to:
based upon the type of the yet to be generated model, assign an identifier to the generated model; and
store the generated model in a database under a respective category corresponding to the identifier.

18. The computer system of claim 17, wherein assigning the identifier to the generated model comprises tagging a name of the generated model with the identifier.

19. The computer system of claim 17, wherein the database is an in-memory database.

20. The computer system of claim 13, wherein the data source comprises one of a database table, a model, and a view.
